(19) United States
(12) Patent Application Publication
(10) Pub. No.: US 2010/0233391 A1
(43) Pub. Date: Sep. 16, 2010

(54) Ink- Jet Recording Medium

(76) Inventors: Yasuyuki Kumada, Kyoto (JP); Shigeru Nawa, Kyoto (JP); Hiroki Furusawa, Kyoto (JP); Yasuhide Yoshida, Oita (JP)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/223,156

(22) PCT Filed: Jan. 29, 2007
(86) PCT No.: PCT/JP2007/051396

§ 371 Date: Jul. 23, 2008

(30) Foreign Application Priority Data
Jan. 30, 2006 (JP) 2006-020564

(51) Int. Cl. B41M 5/50

(52) U.S. Cl. 428/32.21; 428/32.25; 428/32.34; 428/32.37

(57) ABSTRACT

This invention provides an ink-jet recording medium which improves balance between ink absorption and print image quality by ink-jet printing and is excellent in quick drying properties after printing and has an ink absorbing layer with high image quality.

In the ink-jet recording medium, at least one ink absorbing layer including a material containing 5 to 90 wt % of a calcium carbonate pigment in terms of solid content is disposed on one side or both sides of a substrate, and this calcium carbonate pigment is one in which silica formed from soda silicate and calcium chloride is subjected to chemical or physical adsorption treatment on the surface of calcium carbonate particles so that the weight ratio of SiO₂ to CaO is in a range of 2.0 to 80%, and the calcium carbonate pigment and the silica are preferably intertwined into a spherical form of 0.3 to 20 μm. Further, when a compound of alumina hydrate and polyethylene oxide is contained in an amount of 1 to 50 wt % in terms of solid content in the ink absorbing layer, an ink-jet recording medium excellent in blur-resistance, ink absorption and water-resistance of the printed material can be obtained.

### TECHNICAL FIELD

The present invention relates to an ink-jet recording medium used in a so-called ink-jet recording method in which an image is formed by ejecting ink using a dye or ink using a colored pigment from an ink jet ejection port and impacting ejected ink droplets on a recording medium.

### BACKGROUND ART

The ink-jet recording method is utilized as an output unit of personal computer in an extremely wide range of printmaking and printing of general documents for office, printing of industrial documents such as telephone bill accounts, surface printing of corrugated board, ink-jet thermal transfer printing for transcribing on a cloth substrate such as T-shirt for decoration, and the like. The ink-jet recording method generally includes a thermal printing method in which ink is ejected through a nozzle from an ink reservoir such as an ink cartridge by vapor pressure caused by heating; a piezo method in which ink is ejected by converting an electric signal into pressure using a piezoelectric element; and the like. These methods are characterized in that an image can be formed without coming into contact with a print head by impacting ejected ink droplets on a recording medium such as paper or cloth. In recent years, a printer with the volume of an ink droplet reduced to several picoliters has also been developed, and further a printer with a resolution of recorded images exceeding 1440 dot/inch has been developed. Meanwhile, technology for increasing the print speed is advanced for industrial use and a high speed printer which can print at a print speed of 100 to 150 m/min has also been developed and used in practice. Ink used for ink-jet recording includes dye ink in which a dye such as an acid dye as a color material is dissolved in a solvent such as water or alcohol, and pigment ink in which a colored pigment is dispersed in water or alcohol, and a printer is also provided in which both types of ink are used with respect to each color in a printer. A solvent or dispersion medium of ink also includes a solvent type using a quick-drying solvent such as methyl ethyl ketone for improving drying properties, other than water and alcohol.

In recent years, a number of ink-jet recording media corresponding to such diversified ink-jet printers have been developed and used. As the ink-jet recording media, extremely many kinds of media such as plain paper, exclusive paper having an ink absorbing layer formed on a substrate such as paper or a film, glossy paper, semi-glossy paper, cloth and non-woven fabric are produced and sold. In such diversified ink-jet recording media, in order to ensure clear print at a resolution exceeding 300 dot/inch, various materials are used as a constituting a recording medium and used in combination depending on the application. In general, an ink absorbing layer is conventionally formed by dispersing a porous pigment such as silica in a water-soluble binder such as polyvinyl alcohol, adding a cationic fixing agent having a dye adsorption performance to form a coating solution and uniformly applying the obtained coating solution to a substrate by a roll coater, an air knife coater, a gravure coater, a blade coater or the like to dry the coating solution. Silica, calcium carbonate, a water-soluble binder and a cationic fixing agent used for this purpose are extremely wide-ranging (see, for example, the following Patent Documents 1, 2 and 3).
Patent Document 1: Japanese Laid-Open Patent Publication No. S60-204390
Patent Document 2: Japanese Laid-Open Patent Publication No. S62-183382
Patent Document 3: Japanese Laid-Open Patent Publication No. 2001-146071

However, in such a porous ink absorbing layer based on silica, when ink absorption is increased, ink penetrates into the inside of the absorbing layer, and therefore the color is not vivid. On the other hand, when ink absorption is decreased, penetration of ink is poor and a print image is blurred, and therefore it was difficult to keep a balance between ink absorption and print image quality. Further, in a porous ink absorbing layer including a blend composition of silica and calcium carbonate, when printing is performed on ink-jet paper processed by a mixed system of different types of inorganic pigments, there is a case where mottling easily occurs and there is a tendency that the water-resistance is impaired; the stability of a coating solution becomes worse; or the viscosity of a coating solution is increased, and therefore it is difficult to adapt the mixed system to size press processing and gate roll processing in which a coating material can be processed at low viscosity, under the present circumstances.

### DISCLOSURE OF THE INVENTION

An object of the present invention is to provide an ink absorbing layer with high image quality which improves the balance between ink absorption and print image quality by the above ink-jet printing and is excellent in quick drying properties after printing. Generally, the ink absorbing layer is divided broadly into: a porous absorbing layer for absorbing ink from a porous absorbing layer by a capillary action; and a wet absorbing layer having a nature of absorbing a solvent and a dispersion medium of ink. In the present invention, a silica-calcium carbonate complex pigment which is formed by special treatment of a porous pigment usable for the former porous absorbing layer (hereinafter, referred to as “calcium carbonate pigment”) and a compound of alumina hydrate and polyethylene oxide are used in combination, and thereby the balance between ink absorption and print image quality can be improved and an image having a high sharpness can be obtained, and simultaneously an ink absorbing layer having good water-resistance can be provided. Further, an ink absorbing layer which can also exhibit good print image quality for pigment ink in which image quality formation is difficult in a wet absorbing layer can be provided.

The ink-jet recording medium of the present invention which can solve the above problems is characterized in that at least one ink absorbing layer is disposed on one side or both sides of a substrate constituting a medium and the ink absorbing layer contains a calcium carbonate pigment in which silica is subjected to chemical or physical adsorption treatment on the surface of calcium carbonate particles and a compound of alumina hydrate and polyethylene oxide.

Further, the present invention is characterized in that the calcium carbonate pigment in the ink-jet recording medium having the above features is one in which the silica is subjected to chemical or physical adsorption treatment so that the weight ratio of SiO₂ to CaO is in a range of 2.0 to 80%, and preferably in a range of 5 to 50%, and is a particle having an average particle size of 0.3 to 20 μm.

Further, the present invention is characterized in that the ink absorbing layer contains 5 to 90 wt % of the calcium carbonate pigment in terms of solid content and 1 to 50 wt % of a compound of alumina hydrate and polyethylene oxide in terms of solid content, and the ratio of alumina hydrate to polyethylene oxide is in a range of 10:90 (wt %) to 90:10 (wt %), and preferably in a range of 20:80 (wt %) to 50:50 (wt %) in terms of solid content.

In the ink-jet recording medium having the above features, the calcium carbonate pigment is converted into an aqueous dispersion containing particles of 10 μm or less under vigorous stirring in water by a disperser. Further, a polymer of a cationic polymer, an anionic polymer or an amphoteric polymer is added to the calcium carbonate pigment, as required so that the solid content weight ratio of the calcium carbonate pigment/the polymer becomes a ratio of 100 parts by weight/1 to 50 parts by weight, and thereby a dispersion which has been ground and processed in a range of an average particle size of 0.1 to 10 μm in water by a disperser and a homogenizer can be obtained. The present invention is characterized by containing an aqueous dispersion of the calcium carbonate pigment.

Further, the present invention is characterized in that the specific surface area of the calcium carbonate pigment is in a range of 5 to 200 m²/g and the oil absorption is in a range of 30 to 300 ml/100 g in the ink-jet recording medium having the above features.

Further, the present invention is characterized in that the ink absorbing layer contains 5 to 50 wt % of a water-soluble binder in terms of solid content, in the ink-jet recording medium having the above features.

Further, the present invention is characterized in that the substrate is a paper substrate and the ink absorbing layer is formed by coating and impregnating by a size press method or a gate roll method in the ink-jet recording medium having the above features.

In the ink-jet recording medium of the present invention, the balance between ink absorption and print image quality in ink-jet printing is improved and quick drying properties after printing are also excellent and print images with high image quality can be formed by an ink absorbing layer containing a special calcium carbonate pigment as compared with one having an ink absorbing layer based on silica. In addition, the ink absorption, color density and water-resistance of a printed matter can be improved by adding a blend of alumina hydrate and polyethylene oxide to an ink absorbing layer.

### BRIEF DESCRIPTION OF THE DRAWINGS

FIG. 1 is an example of a macrophotograph (magnification: 30,000 times) of calcium carbonate before treating the surface with silica.

FIG. 2 is an example of a macrophotograph (magnification: 60,000 times) of a calcium carbonate pigment after treating the surface with silica.

### BEST MODES FOR CARRYING OUT THE INVENTION

Hereinafter, the ink absorbing layer of the ink-jet recording medium of the present invention will be described in detail.

The ink absorbing layer of the ink-jet recording medium is generally formed using, as a main material, a porous pigment of a inorganic pigment such as silica, alumina, calcium carbonate, and kaolin, an organic pigment such as a plastic pigment, or the like; a binder such as polyvinyl alcohol, polyvinylpyrrolidone, an acrylic resin, a urethane resin or an ethylene-vinyl acetate copolymer; or a cationic resin such as polyamine type, dicyandiamide type, allyl type or acrylic type. Among these materials, silica is particularly used for forming a porous absorbing layer in many cases. As the binder, polyvinyl alcohol having high ink wettability is used in many cases. As the cationic resin, a polyamine type having high dye fixation effect is generally used. The necessary amount of each of these materials is dissolved or dispersed in water to form a coating material, and then the coating material is coated on paper, synthetic paper, a film made of polyethylene terephthalate or the like, or non-woven cloth by a coater such as an air knife coater, a blade coater, a gravure coater, a curtain coater or a comma coater. The coated amount of an ink absorbing layer is generally 5 to 15 g/m².

In the preset invention, a calcium carbonate pigment is used as a porous pigment. As the calcium carbonate pigment, one in which silica is subjected to adsorption treatment on the surface of calcium carbonate particles is used, and calcium a carbonate pigment is particularly used in which silica formed from sodium silicate and calcium chloride is chemically or physically adsorbed onto the surface of calcium carbonate particles so that the weight ratio of SiO₂ to CaO is in a range of 2.0 to 80%, and preferably a ratio of 5 to 50%, and then pulverized into particles having an average particle size of 0.3 to 20 μm. The calcium carbonate pigment according to the present invention is used at a solid content ratio of 5 to 90% for an ink absorbing layer, and thereby an ink-jet recording medium with good balance between ink absorption and print quality such as print sharpness can be formed.

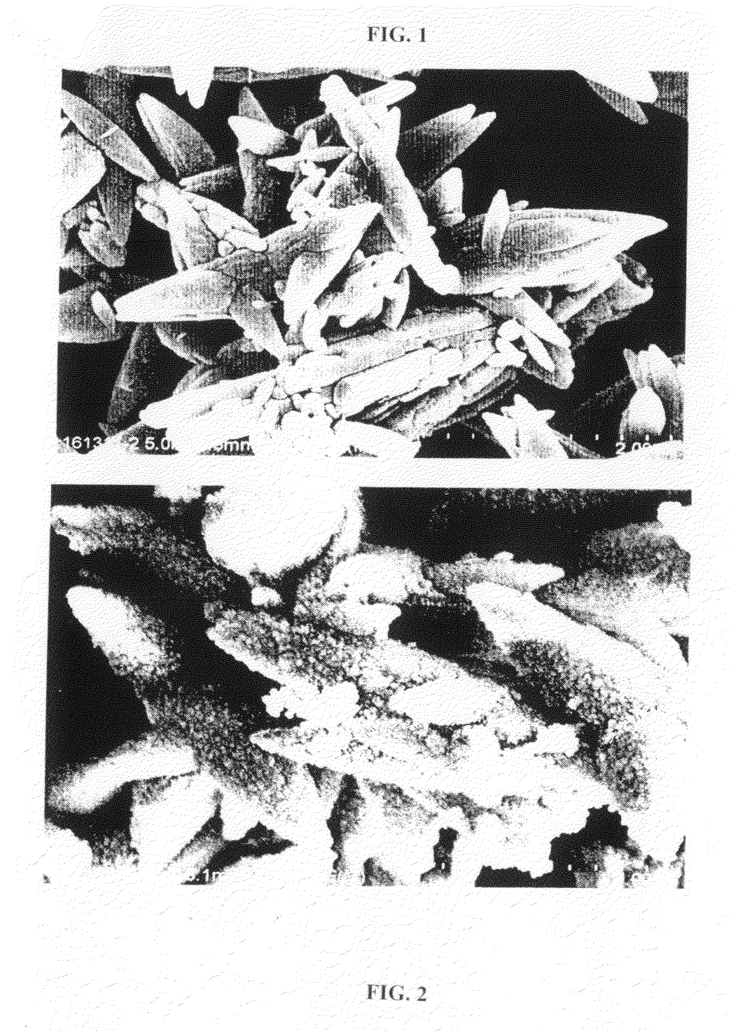

FIG. 1 is a macrophotograph (magnification: 30,000 times) of calcium carbonate before treating calcium carbonate with silica, FIG. 2 is a macrophotograph (magnification: 60,000 times) of a calcium carbonate pigment after treating calcium carbonate with silica.

Here, an example of a method for producing calcium carbonate pigment will be described. Calcium carbonate particles can be formed by adding carbon dioxide to calcium hydroxide.

Ca(OH)₂+CO₂→CaCO₃ [Chem. 1]

A method for complexing silica to calcium carbonate is performed, for example, by treating calcium carbonate produced by the above reaction with sodium silicate and calcium chloride. The synthesis reaction formula of silica occurring when silica is adhered to the surface of calcium carbonate is shown below.

Na₂O.nSiO₂.XH₂O+CaCl₂→nSiO₂+2NaCl [Chem. 2]

After synthesizing silica, 2NaCl is washed with water and removed.

The calcium carbonate pigment obtained by the above reaction process is in a state where silica surrounds the surface of calcium carbonate in a chemically and physically close state as shown in FIG. 2, which leads to the fact that the pigment has useful physical properties as an ink-jet processing agent as described below, as compared with the case where calcium carbonate and silica are simply mechanically blended or mixed.

In the case of the composition where calcium carbonate and silica are simply mechanically blended, calcium carbonate is usually anionic, and when calcium carbonate and silica are mechanically dispersed in an aqueous system, a phenomenon such as agglomeration or increased viscosity easily occurs, a coating material having good stability and low viscosity is difficult to be produced, and therefore it is difficult to perform size press processing or gate roll processing. When printing is performed on inkjet paper on which a coating material containing such a composition is applied by coating processing using a color printer, mottling easily occurs and the water-resistance of ink is poor in many cases. On the contrary, an aqueous dispersion of a coating material containing the calcium carbonate pigment of the present invention has good solution stability, and precipitation and agglomeration are difficult to occur even at low concentration, and therefore it becomes possible to perform size press processing or gate roll processing, and when printing is performed on inkjet paper processed using these processings by a color printer, mottling does not occur, and print density and water-resistance are significantly improved as compared with the case of a simple blend.

In the present invention, it is preferred that a calcium carbonate pigment has a specific surface area of 5 to 200 m²/g and an oil absorption of 30 to 300 ml/100 g. When the specific surface area and the oil absorption are less than 5 m²/g and 30 ml/100 g, respectively, ink absorption becomes worse, and it is difficult to increase these values of the specific surface area and the oil absorption from the viewpoint of production technology. In the present invention, it is necessary to exhibit good ink absorption that the calcium carbonate pigment formed in such a manner is contained in an amount of 5 to 90 wt % in terms of solid content in an ink absorbing layer. When the content of the calcium carbonate pigment in an ink absorbing layer is too small, the balance between ink absorption and print image quality becomes worse, and therefore it becomes difficult to exhibit good print quality. On the other hand, when the content is too large, the binding ability of a binder between pigments becomes poor, and in the extreme case, an ink absorbing layer is peeled off when rubbed with a finger, which leads to deterioration of adhesion strength.

In the present invention, the above calcium carbonate pigment is mixed in a dispersion medium such as water, as required together with polymers of a cationic polymer such as polyamine, an anionic polymer containing a sodium carboxylate group or the like, an amphoteric polymer having both cationic and anionic properties, and the like, and then pulverized into particles having a suitable particle size by a sand mill or the like. In this case, the weight ratio of a calcium carbonate pigment to a polymer is preferably about 100:1 to 100:50. When the amount of the polymer added is small, the dispersion stability of pigment slurry becomes worse, and when the amount of the polymer added is too large, ink absorption becomes poor as a pigment material. The average particle size of the calcium carbonate pigment obtained by pulverization treatment is desirably in a range of 0.1 to 20 μm. It is difficult to pulverize particles having a particle size of less that 0.1 μm by a general wet grinding method such as sand milling. When the particle size is coarser than 20 μm, coating becomes difficult when the calcium carbonate pigment is formed into a coating material. In addition, the solid content concentration of the pigment slurry in this case is about 5 to 50%. When the solid content concentration is too low, the coated amount when the calcium carbonate pigment is formed into a coating material is decreased and therefore print image quality is deteriorated. On the other hand, when the solid content concentration is too high, the slurry viscosity is increased and it becomes difficult to handle the slurry, the viscosity when the calcium carbonate pigment is formed into a coating material is also too high, and in the extreme case, the slurry cannot be coated by a coater.

In the present invention, it is an essential condition to contain a compound of alumina hydrate and polyethylene oxide in an ink absorbing layer. Colloidal Alumina is a colloidal solution of alumina containing water as a dispersion medium, and usually has an average particle size of 1 nm to 500 nm. Aluminum contained in alumina hydrate shows cationic properties in a state where a hydroxyl group, a water molecule or the like is bound to aluminum, and allows anions (including, for example, a hydrochloride ion, an acetate ion, a nitrate ion and a phosphate ion) in water to disperse as a stabilizing agent. Aluminum contained in alumina hydrate is charged with a high positive charge and has high adsorption to a material charged with a negative charge, and therefore has the nature that it is strongly adsorbed and bound to anionic dye and pigment used for ink-jet ink, so that water-resistance and color density of the printed material are improved when alumina hydrate is mixed in an ink-jet coating solution. A method for producing alumina hydrate includes, for example, one which is described in the following Patent Document 4 or 5.
Patent Document 4: Japanese Examined Patent Publication No. S39-20150
Patent Document 5: Japanese Examined Patent Publication No. S40-8409

Alumina hydrate has high cationic properties and therefore has poor compatibility with other chemicals, especially poor mixing ability or compatibility with salts having anionic properties, and the state of the solution becomes unstable even by the change of temperature or pH, thereby easily causing inconveniences such as increased viscosity and agglomeration. In the present invention, when colloidal alumina and polyethylene oxide are mixed in an aqueous system, colloidal particles in alumina hydrate converted into a protective colloid by affinity between the colloidal particles in alumina hydrate and ether groups in polyethylene oxide for stabilization. Therefore, in the case of mixing with a calcium carbonate pigment, a cationic fixing agent and a binder which are mixed thereafter, almost no shock is caused and a stable ink-jet coating solution can be obtained without increasing the viscosity of the entire coating solution or agglomerating it. Particularly, when calcium carbonate and alumina hydrate are directly mixed, gelation instantaneously occurs, but the surface of calcium carbonate is covered with silica and alumina hydrate is mixed after converted into a protective colloid by polyethylene oxide for stabilization in the method of the present invention, and therefore a blend of an ink-jet coating solution can be obtained without causing inconveniences of increased viscosity, gelation, agglomeration and the like even in a water-based coating solution having a composition containing calcium carbonate, silica and alumina, thereby leading to completion of the formulation of the present invention. Polyethylene oxide used herein is in itself a long-chain polymer having a molecular weight of tens of thousands to several millions, and has characteristics that when the polyethylene oxide is added to an ink absorbing layer, ink absorption is not impaired, and on the contrary drying of ink after printing can be performed in a short period of time due to high water absorption of polyethylene oxide itself. As a matter of course, it is needless to say that polyethylene oxide is a polymer and also has performance as a binder. Further, polyethylene oxide has a high molecular weight as compared with polyvinyl alcohol and the like, and therefore has appropriate viscosity when formed into a coating solution, and also has a function for stabilizing the calcium carbonate pigment to prevent sedimentation. In the present invention, a compound of alumina hydrate and polyethylene oxide is added to a calcium carbonate pigment as required in such a manner. The solid content ratio of the compound of alumina hydrate and polyethylene oxide in an ink absorbing layer is preferably 1 to 50 wt %. When the ratio is less than 1 wt %, the water-resistance of the printed material is reduced, and on the contrary, when the ratio is more than 50 wt %, ink absorption after printing is caused to be reduced. Since alumina hydrate itself has an average particle size of 5 to 500 nm and exhibits a very dense layer structure when dried and solidified, a porous layer for absorbing ink is difficult to be formed. Therefore, it is necessary to increase ink absorption by using an appropriate amount of the above-mentioned calcium carbonate pigment to form a porous state. In addition, the mixing ratio of alumina hydrate to polyethylene oxide is in a range of 10:90 (wt %) to 90:10 (wt %), and preferably in a range of 20:80 (wt %) to 50:50 (wt %). When the ratio of alumina hydrate is increased, the water-resistance of the printed material is improved, but miscibility with a calcium carbonate pigment is reduced, and thereby the viscosity of a coating solution is extremely increased, and when the ratio of alumina hydrate is decreased, the water-resistance of the printed material is reduced. Such a mixing ratio needs to be appropriately selected and used depending on the particle size, shape and neutralization form of alumina hydrate and the average molecular weight of polyethylene oxide. Polyethylene oxide having a molecular weight of about 100,000 can form an aqueous solution of 10 to 20 wt % of polyethylene oxide. When the solid content concentration is high, the final solid content concentration can be increased when the blend is formed into a coating material, and when a coating material is applied onto a substrate such as paper, the amount of the coating solution adhered can be increased. Although polyethylene oxide having a molecular weight of about 1,000,000 has high viscosity in an aqueous solution of several % of polyethylene oxide, the stability of alumina hydrate tends to be increased. Generally, polyethylene oxide having high molecular weight is unstable because the molecular chain is easily cut, and therefore when it is stored for a long period of time, stabilizing agents such as hindered phenol-based compound, hindered amine-based compound and other various antioxidants are added to the polyethylene oxide.

Examples of the binder usable in the present invention include various water-soluble binders, for example, polyvinyl alcohol, various starches, acrylic emulsion, urethane emulsion and an ethylene-vinyl acetate copolymer, but are not limited to specific materials. Among various water-soluble binders, starch has excellent miscibility with the calcium carbonate pigment and the compound of alumina hydrate and polyethylene oxide used in the present invention, and can improve ink absorption during ink-jet printing. The ratio of starch occupied in an ink absorbing layer is desirably 5 to 50 wt %. When the amount used is less than 5 wt %, the binder function is not exhibited, and on the other hand, when the ratio is more than 50 wt %, the ratio of a pigment becomes relatively small, and therefore ink absorption during printing is deteriorated. When starch for sizing is used, an aqueous solution of phosphate-based starch shows anionic properties, and therefore it needs to be taken into consideration that phosphate-based starch is used after diluted such an extent that agglomeration with a dye fixing agent does not occur.

Examples of the ink fixing agent usable in the present invention include cationic water-soluble polymer compounds, for example, polyethyleneimine salts, a dimethylamine epihalohydrin condensate, polyvinylamine salts, polyallylamine salts, polydimethylaminoethyl methacrylate, polydiallyldimethyl ammonium salts, a diallylamine-acrylamide copolymer, polystyrene quaternary ammonium salts, a dicyandiamide-polyalkylene polyamine condensate, and the like, but are not limited to these materials. The cationic water-soluble polymer compounds are used for the purpose of forming water-resistant of printed text and image on an ink absorbing layer, improving print density, preventing ink blur, and the like. Although a suitable amount of each of these compounds used is in a range of 1 to 70 wt % of an ink absorbing layer in terms of solid content, when the amount used is small depending on the condition, the effect may be small, and when the used amount is large, tone abnormality may be caused or the binder effect may be impaired, and therefore each compound is desirably contained in an amount of 10 to 30 wt %.

When the calcium carbonate pigment is used as a coating solution, a compound of alumina hydrate and polyethylene oxide, and a binder are added to the calcium carbonate pigment as required, and in the case of forming an ink absorbing layer corresponding to dye ink, or the like, a cationic fixing agent is added as required, and auxiliaries such as antifoaming agents, fluorescent brighteners and coloring agents such as blue dye and blue pigment are added so that a solid content concentration of the resulting mixture is 5 to 60%, and each material is uniformly dispersed and mixed using a dispersing machine such as a disperser, homogenizer or sand mill. As a matter of course, pigments such as silica, alumina and kaolin may be used together with the calcium carbonate pigment. A substrate of paper is applied and impregnated with the thus obtained coating solution by a size press method or gate roll method. The coated amount is preferably 0.5 to 5 g/m² in terms of the weight after drying. When the coated amount is too small, the print image quality becomes worse, and when the coated amount is too large, the ink absorption generally becomes good, but the sharpness of color becomes worse because ink deeply penetrates into an ink absorbing layer. In the size press method or gate roll method, the treatment process can be performed by on-machine in a paper machine for forming paper, and the number of production process becomes less and production efficiency can be improved compared with the coating process by off-machine. Further, a low-cost ink-jet recording medium with high print quality can be produced by setting the coated amount to 0.5 to 5 g/m².

Hereinafter, the examples according to the present invention will be described to explain the effects, but it is needless to say that the embodiments according to the present invention should not be limited to these examples.

### Examples

### Example 1

To a slurry solution which has a weight ratio of SiO₂/CaO of about 25% to 75% and was prepared to have an average particle size of 2.5 μm (ABSOLITE TB-240R1 produced by KOMESHO SEKKAI KOGYO CO., LTD.) (solid content concentration: 35%; specific surface area: 90 m²/g; and oil absorption: 130 ml/100 g) as a calcium carbonate pigment were added a compound of alumina hydrate (hydrochloride) and polyethylene oxide (ALKOSOL JK-240 produced by MEISEI CHEMICAL WORKS, LTD.), a polyamine-based cationic polymer (PALSET JK-505 produced by MEISEI CHEMICAL WORKS, LTD.) as a fixing agent, and a 10% aqueous solution of oxidized starch (MS-3600 produced by NIHON SHOKUHIN KAKO CO., LTD.) as a binder, and then water was added to the resulting mixture to prepare a coating solution having a solid content concentration of 13% and a viscosity of 150 mPa·s. The blend ratio of solid content of each material is as follows.

| | |
|---|---|
| Calcium carbonate pigment | 52 parts by weight of |
| Compound of alumina hydrate and polyethylene | 5 parts by weight |
| oxide | |
| Fixing agent | 10 parts by weight |
| Binder | 33 parts by weight |

The above coating material was subjected to size press on no-size base paper (no-size paper of 90 g/m²) in the condition of a roll pressure of 4 kg/cm by a two-roll size press and dried at a drying temperature of 110° C. for 1 minute using a drum dryer so that the ink absorbing layer after drying had a coated amount of 4 g/m² (both sides), and thereby an ink-jet recording medium was obtained.

In addition, the above coating material was subjected to bar coating (Rod No. 12) on no-size base paper (no-size paper of 90 g/m²) and dried at a drying temperature of 110° C. for 1 minute using a hot air dryer so that the ink absorbing layer after drying had a coated amount of 2 g/m² (one side), and thereby an ink-jet recording medium was obtained.

The print quality was determined by performing printing using EPSON STYLUS PHOTO R200 (dye ink use) manufactured in U.S., and visually observing the sharpness of printed matter and measuring the Optical density by a spectrocolorimeter SE-2000 (NIPPON DENSHOKU INDUSTRIES CO., LTD.: KCMY density JIS K7653, ISO 5/3). The water-resistance of printed matter was determined by visual observation, by immersing the printed sample in water for 10 seconds, then placing filter paper on the sample to press it from the upper side with a roll, and examining ink blur of the printed matter and transfer of the printed matter onto the filter paper. The results are shown in Table 1.

### Example 2

To a powder having a weight ratio of SiO₂/CaO of about 6% to 94% and an average particle size of about 3 μm (ABSOLITE TB-314 (specific surface area: 20 m²/g; and oil absorption: 60 ml/100 g) produced by KOMESHO SEKKAI KOGYO CO., LTD.) as a calcium carbonate pigment were added a compound of alumina hydrate and polyethylene oxide (ALKOSOL JK-240 produced by MEISEI CHEMICAL WORKS, LTD.) (Solid content concentration: 20%), and a polyamine-based cationic polymer (PALSET JK-505 produced by MEISEI CHEMICAL WORKS, LTD.), and then a 10% aqueous solution of oxidized starch (MS-3600 produced by NIHON SHOKUHIN KAKO CO., LTD.) as a binder was added to the resulting mixture, and water was added thereto to prepare a coating material having a solid content concentration of 13%. The obtained coating solution had a viscosity of 130 mPa·s and good coating solution stability. The blend ratio of solid content of each material is as follows.

| | |
|---|---|
| Calcium carbonate pigment | 52 parts by weight |
| Compound of alumina hydrate and polyethylene | 5 parts by weight |
| oxide | |
| Binder | 33 parts by weight |
| Cationic polymer | 10 parts by weight |

An ink-jet recording medium was obtained using the above coating solution in the same manner as in Example 1. The printing evaluation was performed for this recording medium in the same manner as in Example 1. The results are shown in Table 1.

### Example 3

To a powder having a weight ratio of SiO₂/CaO of about 25% to 75% and an average particle size of about 3.5 μm (ABSOLITE TB113 produced by KOMESHO SEKKAI KOGYO CO., LTD.) as a calcium carbonate pigment were added a blend of alumina hydrate and polyethylene oxide (ALKOSOL JK-240 produced by MEISEI CHEMICAL WORKS, LTD.), and a polyamine-based cationic polymer (PULSET JK-525 produced by MEISEI CHEMICAL WORKS, LTD.) as a fixing agent, and then polyvinyl alcohol, an ethylene-vinyl acetate copolymer (AIRFLEX 110 Emulsion produced by AIR PRODUCTS) and a 10% aqueous solution of oxidized starch (MS-3600 produced by NIHON SHOKUHIN KAKO CO., LTD.) as binders were added to the resulting mixture, and water was added thereto to prepare a coating solution having a solid content concentration of 13%. The prepared coating solution had a viscosity of 160 mPa·s and good coating solution stability. The blend ratio of solid content of each material is as follows.

| | |
|---|---|
| Calcium carbonate pigment | 145 parts by weight |
| Compound of alumina hydrate and polyethylene | 15 parts by weight |
| oxide | |
| Fixing agent | 30 parts by weight |
| Binder | 77 parts by weight |

An ink-jet recording medium was obtained using the above coating solution in the same manner as in Example 1. The printing evaluation was performed for this recording medium in the same manner as in Example 1. The results are shown in Table 1.

### Example 4

To a powder having a weight ratio of SiO₂/CaO of about 25% to 75% and an average particle size of about 3.5 μm (ABSOLITE TB113 produced by KOMESHO SEKKAI KOGYO CO., LTD.) as a calcium carbonate pigment were added a compound of colloidal alumina (acetate) and polyethylene oxide (ALCOSOL JK-300 produced by MEISEI CHEMICAL WORKS, LTD.) (solid content concentration: 25%), and an allyl-based cationic polymer (PULSET JK-515 produced by MEISEI CHEMICAL WORKS, LTD.) and a polyamine-based cationic polymer (PULSET JK-505 produced by MEISEI CHEMICAL WORKS, LTD.) as fixing agents, and then polyvinyl alcohol, an ethylene-vinyl acetate copolymer (SUMIKAFLEX 400HQ produced by Sumitomo Chemical Co., Ltd.) and a 10% aqueous solution of oxidized starch (MS-3600 produced by NIHON SHOKUHIN KAKO CO., LTD.) as binders were added to the resulting mixture, and water was added thereto to prepare a coating solution having a solid content concentration of 13%. The prepared coating material had a viscosity of 150 mPa·s and good coating solution stability. The blend ratio of solid content of each material is as follows.

| | |
|---|---|
| Calcium carbonate pigment | 145 parts by weight |
| Compound of alumina hydrate and polyethylene | 15 parts by weight |
| oxide | |
| Fixing agent | 30 parts by weight |
| Binder | 77 parts by weight |

An ink-jet recording medium was obtained using the above coating solution in the same manner as in Example 1. The printing evaluation was performed for this recording medium in the same manner as in Example 1. The results are shown in Table 1.

### Example 5

A coating solution having a solid content concentration of 13% was prepared in the same formulation as in Example 3 except that the calcium carbonate pigment (ABSOLITE TB113) used in Example 3 was replaced with a calcium carbonate pigment (ABSOLITE TB119: powder having a weight ratio of SiO₂/CaO of 10% to 90% and an average particle size of 1.5 μm). The prepared coating solution had a viscosity of 160 mPa·s and good coating solution stability.

An ink-jet recording medium was obtained using the above coating solution in the same manner as in Example 1. The printing evaluation was performed for this recording medium in the same manner as in Example 1. The results are shown in Table 1.

### Example 6

A coating material having a solid content concentration of 13% was prepared in the same formulation as in Example 3 except that the calcium carbonate pigment (ABSOLITE TB-113) used in Example 3 was replaced with a calcium carbonate pigment (ABSOLITE TB-323: powder having a weight ratio of SiO₂/CaO of about 30% to 70% and an average particle size of 7 μm). The prepared coating solution had a viscosity of 170 mPa·s and good coating solution stability.

An ink-jet recording medium was obtained using the above coating solution in the same manner as in Example 1. The printing evaluation was performed for this recording medium in the same manner as in Example 1. The results are shown in Table 1.

### Comparative Example 1

An ink-jet recording medium was obtained in the same manner as in Example 2 except that light calcium carbonate powder having an average particle size of 2.5 μm was used in place of the calcium carbonate pigment used in Example 2. The printing evaluation was performed for this recording medium in the same manner as in Example 2. The results are shown in Table 1.

### Comparative Example 2

A coating solution was prepared in the same manner as in Example 1 except that a silica fine powder having a particle size of 2.5 μm was used in place of the calcium carbonate pigment used in Example 1, but heavy silica precipitation occurred, and therefore stable coating could not be performed.

### Comparative Example 3

A coating solution in which a light calcium carbonate powder having an average particle size of 2.5 μm was used in place of the calcium carbonate pigment used in Example 2 and the compound of alumina hydrate and polyethylene oxide was removed was prepared. The resulting coating material had a solid content concentration of 13% and a viscosity of 80 mPa·s The blend ratio of solid content of each material is as follows.

| | |
|---|---|
| Light calcium carbonate powder | 42 parts by weight |
| Starch oxide | 50 parts by weight |
| Cationic polymer | 8 parts by weight |

An ink-jet recording medium was obtained in the same manner as in Example 1. The printing evaluation was performed for this recording medium in the same manner as in Example 1. The results are shown in Table 1. The color density and water-resistance of the print image quality were significantly deteriorated as compared with those in Example 2.

### Comparative Example 4

To calcium carbonate (ABSOLITE DA-619 produced by KOMESHO SEKKAI KOGYO CO., LTD.) and silica (SYLOID 74X5500) as a calcium carbonate pigments were added a compound of alumina hydrate and polyethylene oxide (ALKOSOL JK-240 produced by MEISEI CHEMICAL WORKS, LTD.), and a polyamine-based cationic polymer (PALSET JK-525 produced by MEISEI CHEMICAL WORKS, LTD.) as a fixing agent, and then polyvinyl alcohol, an ethylene-vinyl acetate copolymer (AIRFLEX 110 Emulsion produced by AIR PRODUCTS) and a 10% aqueous solution of oxidized starch (MS-3600 produced by NIHON SHOKUHIN KAKO CO., LTD.) as binders were added to the resulting mixture, and water was added thereto to prepare a coating solution having a solid content concentration of 13%. The viscosity of the resulting coating solution was as high as 1100 mPa·s, and therefore coating by size press was impossible. The blend ratio of solid content of each material is as follows.

| | |
|---|---|
| Calcium carbonate | 102 parts by weight |
| Silica | 43 parts by weight |
| Compound of alumina hydrate and polyethylene | 15 parts by weight |
| oxide | |
| Fixing agent | 30 parts by weight |
| Binder | 77 parts by weight |

An ink-jet recording medium was obtained using the above coating solution in the same manner as the bar coating method in Example 1. The printing evaluation was performed for this recording medium in the same manner as in Example 1. The results are shown in Table 1.

### Comparative Example 5

To a powder having a weight ratio of SiO₂/CaO of 25% to 75% and an average particle size of about 3.5 μm (ABSOLITE TB-113 produced by KOMESHO SEKKAI KOGYO CO., LTD.) as calcium carbonate pigment was added a polyamine-based cationic polymer (PULSET JK-525 produced by MEISEI CHEMICAL WORKS, LTD.) as a fixing agent, and then polyvinyl alcohol, an ethylene-vinyl acetate copolymer (AIRFLEX 110 Emulsion produced by AIR PRODUCTS) and a 10% aqueous solution of oxidized starch (MS-3600 produced by NIHON SHOKUHIN KAKO CO., LTD.) as binders were added to the resulting mixture, and water was added thereto to prepare a coating solution having a solid content concentration of 13% and a viscosity of 100 mPa·s. The blend ratio of solid content of each material is as follows.

| | |
|---|---|
| Calcium carbonate pigment | 145 parts by weight |
| Fixing agent | 30 parts by weight |
| Binder | 77 parts by weight |

An ink-jet recording medium was obtained using the above coating solution in the same manner as in Example 1. The printing evaluation was performed for this recording medium in the same manner as in Example 1. The results are shown in Table 1.

TABLE 1
Summary of analysis results of ink-jet color

| | | Mixture of | | | | | | | | | | Optical | |
|---|---|---|---|---|---|---|---|---|---|---|---|---|---|
| | Calcium | (Alumina | | Fixing | Viscosity | | | | | Optical | | density (Size | |
| Example/ | carbonate | hydrate + | | agent | of coating | Coating | Blur of | Water- | | density | | press | |
| Comparative | pigment | Polyethylene | Water-soluble | (Cationic | material | material | printed | resistance | | (Coating) | | coating) | |
| Example | SiO₂/CaO | oxide) | binder | polymer) | (mPa · s) | stability | matter | Black | Color | Black | Total | Black | Total |
| Example 1 | 25/75 | 5 wt % | Oxidized starch | 10 wt % | 150 | ⊙ | ⊙ | ∘ | ∘ | 1.58 | 4.67 | 1.45 | 4.31 |
| | Slurry | | 33 wt % | | | | | | | | | | |
| | 52 wt % | | | | | | | | | | | | |
| Example 2 | 6/94 | 5 wt % | Oxidized starch | 10 wt % | 130 | ⊙ | ∘ | Δ | ⊙ | 1.51 | 4.58 | 1.39 | 4.24 |
| | Powder | | 33 wt % | | | | | | | | | | |
| | 52 wt % | | | | | | | | | | | | |
| Example 3 | 25/75 | 5.6 wt % | Oxidized starch + | 11.2 wt % | 160 | ⊙ | ⊙ | Δ | ∘ | 1.59 | 4.76 | 1.46 | 4.40 |
| | Powder | | Polyvinyl alcohol + | | | | | | | | | | |
| | 54.3 wt % | | Ethylene-vinyl | | | | | | | | | | |
| | | | acetate copolymer | | | | | | | | | | |
| | | | 28.8 wt % | | | | | | | | | | |
| Example 4 | 25/75 | 5.6 wt % | Oxidized starch + | 11.2 wt % | 150 | ⊙ | ⊙ | Δ | ∘ | 1.56 | 4.66 | 1.40 | 4.29 |
| | Powder | | Polyvinyl alcohol + | | | | | | | | | | |
| | 54.3 wt % | | Ethylene-vinyl | | | | | | | | | | |
| | | | acetate copolymer | | | | | | | | | | |
| | | | 28.8 wt % | | | | | | | | | | |
| Example 5 | 10/90 | 5.6 wt % | Oxidized starch + | 11.2 Wt % | 160 | ⊙ | ⊙ | Δ | ∘ | 1.53 | 4.6 | 1.41 | 4.3 |
| | Powder | | Polyvinyl alcohol + | | | | | | | | | | |
| | 54.3 wt % | | Ethylene-vinyl | | | | | | | | | | |
| | | | acetate copolymer | | | | | | | | | | |
| | | | 28.8 wt % | | | | | | | | | | |
| Example 6 | 30/70 | 5.6 wt % | Oxidized starch + | 11.2 Wt % | 170 | ⊙ | ∘ | Δ | ∘ | 1.55 | 4.65 | 1.44 | 4.33 |
| | Powder | | Polyvinyl alcohol + | | | | | | | | | | |
| | 54.3 wt % | | Ethylene-vinyl | | | | | | | | | | |
| | | | acetate copolymer | | | | | | | | | | |
| | | | 28.8 wt % | | | | | | | | | | |
| Comparative | Light | 5 wt % | Oxidized starch | 10 Wt % | 140 | ∘ | Δ | Δ | ∘ | 1.41 | 4.33 | 1.30 | 3.98 |
| Example 1 | calcium | | 33 wt % | | | | | | | | | | |
| | carbonate | | | | | | | | | | | | |
| | 52 wt % | | | | | | | | | | | | |
| Comparative | Silica | 5 wt % | Oxidized starch | 10 wt % | — | x | — | — | — | — | — | — | — |
| Example 2 | 52 wt % | | 33 wt % | | | | | | | | | | |
| Comparative | Light | None | Oxidized starch | 10 wt % | 80 | ∘ | Δ | x | Δ | 1.38 | 4.23 | 1.26 | 3.89 |
| Example 3 | calcium | | 33 wt % | | | | | | | | | | |
| | carbonate | | | | | | | | | | | | |
| | 52 wt % | | | | | | | | | | | | |
| Comparative | 30/70 | 5.6 wt % | Oxidized starch + | 11.2 wt % | 1100 | Δ | Δ | x | x | 1.49 | 4.55 | — | — |
| Example 4 | (Mixed) | | Polyvinyl alcohol + | | | | | | | | | | |
| | powder | | Ethylene-vinyl | | | | | | | | | | |
| | 54.3 wt % | | acetate copolymer | | | | | | | | | | |
| | | | 28.8 wt % | | | | | | | | | | |
| Comparative | 25/75 | None | Oxidized starch + | 11.9 wt % | 100 | ⊙ | ⊙ | Δ | Δ | 1.47 | 4.49 | 1.34 | 4.21 |
| Example 5 | powder | | Polyvinyl alcohol + | | | | | | | | | | |
| | 57.5 wt % | | Ethylene-vinyl | | | | | | | | | | |
| | | | acetate copolymer | | | | | | | | | | |
| | | | 30.6 wt % | | | | | | | | | | |

[Coating Solution Stability]
Coating solution stability was determined by sedimentation of pigment in a coating material and viscosity of the coating material.
⊙: No sedimentation of a pigment is observed and the viscosity of a coating material is not changed with the elapse of time.
◯: Slight sedimentation of a pigment is observed, but the viscosity of a coating material is not changed with the elapse of time.
Δ: Slight sedimentation of a pigment is observed, and the viscosity of a coating material is increased with the elapse of time.
x: Sedimentation of a pigment or high increase in the viscosity of a coating material is observed and thus is unacceptable for use as a coating material.

### [Blur of Printed Matter]

Outline characters are printed on the solid print of blue, red, green, yellow, black or magenta using EPSON STYLUS PHOTO R200 manufactured in U.S., and the degree in which ink-jet ink caused blur on the side of the outline characters in a state where ink penetration was stable 30 minutes after printing was visually observed.
⊙: No ink blur is observed.
◯: Slight ink blur is observed.
Δ: Ink blur is clearly observed.
x: Outline characters are disappeared by ink penetration.

### [Water-Resistance of Printed Matter]

The water-resistance of printed material was determined by visual observation, by immersing the sample printed using EPSON STYLUS PHOTO R200 manufactured in U.S. (solid print of blue, red, green, yellow, black or magenta: 1 cm×1 cm) in water for 10 seconds, then placing filter paper on the sample to press it from the upper side with a roll, and examining ink blur of the printed material and transfer of the printed material onto the filter paper.
In the case of black ink
⊙: No ink blur is observed and no transfer of printed material onto filter paper is observed.
◯: Slight ink blur is observed and slight transfer of printed material onto filter paper is observed.
Δ: Ink blur is clearly observed and transfer of printed material onto filter paper is observed.
x: Ink blur is clearly observed, and severe color fading of solid print occurs and transfer of printed material onto filter paper is densely observed.
In the case of color ink
⊙: No ink blur is observed and no transfer of printed material onto filter paper is observed.
◯: No ink blur is observed, but slight transfer of printed material onto filter paper is observed.
Δ: Slight ink blur is observed and transfer of printed material onto filter paper is observed for some of colors.
x: Ink blur and transfer of printed material onto filter paper are densely observed for all colors.
[Optical density] Solid printing of black, cyan, magenta or yellow (3 cm×3 cm) was performed using EPSON STYLUS PHOTO R200 manufactured in U.S. and the Optical density was measured by a spectrocolorimeter SE-2000 (NIPPON DENSHOKU INDUSTRIES CO., LTD.: KCMY density JIS K7653, ISO 5/3). The Optical densities of black ink and a total of four colors were shown in Table 1. In coating, when the Optical densities of black ink and a total of four colors were 1.48 or more and 4.5 or more, respectively, the coating material was rated as good. In size press coating, when the Optical densities of black ink and a total of four colors were 1.38 or more and 4.2 or more, respectively, the coating material was rated as good.

In Comparative Example 1, light calcium carbonate is used in place of the calcium carbonate pigment used in Example 1, and therefore the blur and Optical density of printed materials are particularly deteriorated. In Comparative Example 2, the silica fine powder was used in place of the calcium carbonate pigment, and therefore the dispersion stability of silica was poor and a coating solution having good stability could not be obtained. In Comparative Example 3, light calcium carbonate is used in place of the calcium carbonate pigment used in Example 1 and alumina hydrate and polyethylene oxide are further removed, and therefore the water-resistance, Optical density and blur of printed matter are deteriorated. In Comparative Example 4, a simple mixture of silica and calcium carbonate is used in place of the calcium carbonate pigment of Example 5, and therefore the viscosity of a coating material is remarkably increased and the blur and water-resistance are significantly deteriorated. In Comparative Example 5, alumina hydrate and polyethylene oxide used in Example 3 are removed, and therefore the water-resistance and color density of printed matter are deteriorated.

1-11. (canceled)

12: An ink-jet recording medium used in an ink-jet recording method, wherein at least one ink absorbing layer is disposed on one side or both sides of a substrate constituting the medium, and the ink absorbing layer contains a silica-calcium carbonate complex pigment in which silica is subjected to chemical or physical adsorption treatment on the surface of calcium carbonate particles and a compound of alumina hydrate and polyethylene oxide.

13: The ink-jet recording medium according to claim 12, wherein the silica-calcium carbonate complex pigment is one in which silica is subjected to chemical or physical adsorption treatment so that the weight ratio of SiO₂ to CaO is in a range of 2.0 to 80%, and is a particle having an average particle size of 0.3 to 20 μm.

14: The ink-jet recording medium according to claim 12, wherein the ink absorbing layer contains 5 to 90 wt % of the silica-calcium carbonate complex pigment in terms of solid content and 1 to 50 wt % of the compound of alumina hydrate and polyethylene oxide in terms of solid content.

15: The ink-jet recording medium according to claim 12, wherein the specific surface areas of the silica-calcium carbonate complex pigment is in a range of 5 to 200 m²/g and the oil absorption is in a range of 30 to 300 ml/100 g.

16: The ink-jet recording medium according to claim 12, wherein the mixing ratio of the alumina hydrate to the polyethylene oxide is in a range of weight ratio of 10:90 to 90:10 in terms of solid content.

17: The ink-jet recording medium according to claim 12, wherein the ink absorbing layer contains 5 to 50 wt % of a water-soluble binder in terms of solid content.

18: The ink-jet recording medium according to claim 17, wherein the water-soluble binder is selected from the group consisting of polyvinyl alcohol, various starches, acrylic emulsion, urethane emulsion and an ethylene-vinyl acetate copolymer.

19: The ink-jet recording medium according to claim 12, containing 1 to 70 wt % in terms of solid content of a cationic water-soluble polymer compound for the purpose of adding water-resistance and quality improvement of printed text and image on the ink absorbing layer simultaneously.

20: The ink-jet recording medium according to claim 19, wherein the cationic water-soluble polymer compound is selected from the group consisting of polyethyleneimine salts, a dimethylamine epihalohydrin condensate, polyvinylamine salts, polyallylamine salts, polydimethylaminoethyl methacrylate, polydiallyldimethyl ammonium salts, a diallylamine-acrylamide copolymer, polystyrene quaternary ammonium salts and a dicyandiamide-polyalkylene polyamine condensate.

21: The ink-jet recording medium according to claim 12, wherein the ink absorbing layer is formed by coating and impregnating by a size press method ro gate roll method.

22: The ink-jet recording medium according to claim 12, wherein the substrate is a paper substrate.
